(19) United States
(12) Patent Application Publication
(10) Pub. No.: US 2025/0108771 A1
(43) Pub. Date: Apr. 3, 2025

(54) WIRE HARNESS ROUTING STRUCTURE

(71) Applicant: YAZAKI CORPORATION, Tokyo (JP)

(72) Inventors: Junya Kato, Makinohara-shi (JP); Taku Furuta, Makinohara-shi (JP)

(21) Appl. No.: 18/900,612

(22) Filed: Sep. 27, 2024

(30) Foreign Application Priority Data
Oct. 3, 2023 (JP) 2023-172126

(51) Int. Cl. B60R 16/02; B60R 13/08; H02G 3/04

(52) U.S. Cl. CPC B60R 16/0215; H02G 3/0418; B60R 13/08

(57) ABSTRACT

A wire harness routing structure includes: a groove formed in a dash panel which is an example of a body member of a vehicle; a flat routing member having flexibility and accommodated in the groove of the dash panel, and extends along a vehicle width direction; and a lid member which closes the groove in a state where the flat routing member is accommodated in the groove of the dash panel.

### CROSS-REFERENCE TO RELATED APPLICATION(S)

The present application claims priority to and incorporates by reference the entire contents of Japanese Patent Application No. 2023-172126 filed in Japan on Oct. 3, 2023.

### BACKGROUND OF THE INVENTION

### 1. Field of the Invention

The present invention relates to a wire harness routing structure.

### 2. Description of the Related Art

As a technique related to a conventional wire harness routing structure, for example, Japanese Patent Application Laid-open No. 2012-055105 A discloses a wire harness routing structure including a flexible flat routing member, a protector for protecting the flat routing member, and a fixing member for fixing the protector to an attachment portion of a vehicle.

Incidentally, in the wire harness routing structure described in Japanese Patent Application Laid-open No. 2012 055105 A described above, for example, there is room for further improvement in terms of improvement in assemblability to a vehicle.

### SUMMARY OF THE INVENTION

The present invention has been made in view of the above circumstances, and an object thereof is to provide a wire harness routing structure capable of improving assemblability to a vehicle.

In order to achieve the above mentioned object, a wire harness routing structure according to one aspect of the present invention includes a groove formed in a body member of a vehicle; a flat routing member having flexibility and accommodated in the groove of the body member; and a lid member that closes the groove in a state where the flat routing member is accommodated in the groove of the body member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a vehicle to which a wire harness routing structure according to an embodiment is applied;

FIG. 2 is an exemplary perspective view of the wire harness routing structure according to the embodiment;

FIG. 3 is an exemplary exploded perspective view of the wire harness routing structure according to the embodiment; and

FIG. 4 is an exemplary cross-sectional view of the wire harness routing structure according to the embodiment.

### DETAILED DESCRIPTION OF THE PREFERRED EMBODIMENTS

Hereinafter, an embodiment according to the present invention will be described in detail with reference to the drawings. Note that the present invention is not limited by the following embodiment. In addition, constituent elements in the following embodiment include those that can be easily replaced by those skilled in the art or those that are substantially the same. Note that in the present specification, ordinal numbers are used only to distinguish components, members, parts, positions, directions, and the like, and do not indicate order or priority.

### Embodiment

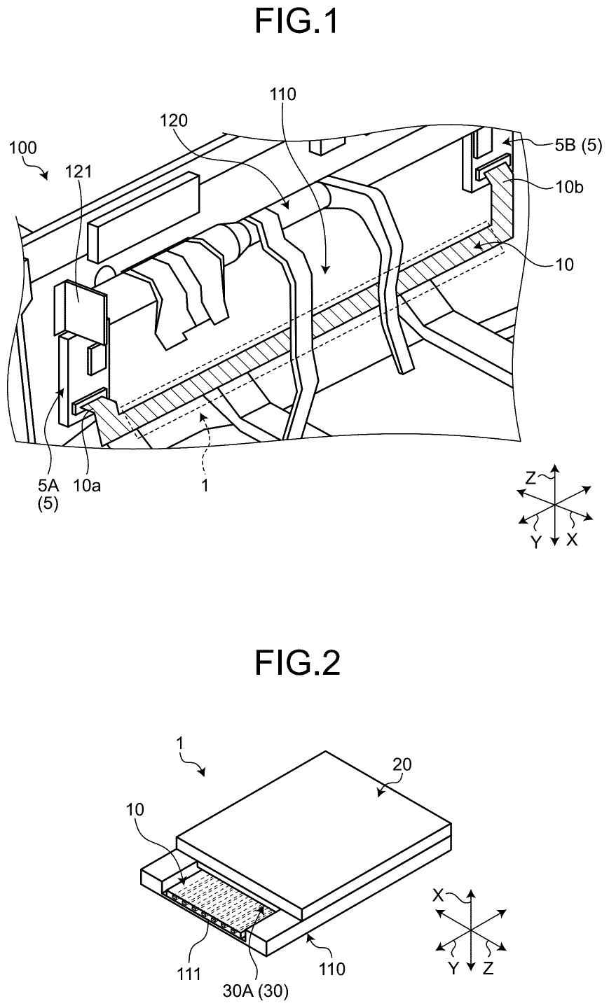

FIG. 1 is a perspective view of a vehicle 100 to which a wire harness routing structure 1 according to an embodiment is applied. The wire harness routing structure 1 of the present embodiment illustrated in FIG. 1 is applied to the vehicle 100, and is used for power supply and signal communication by connecting devices mounted on the vehicle 100. The wire harness routing structure 1 of the present embodiment is provided, for example, on a dash panel 110 which is an example of a body member of the vehicle 100. The dash panel 110 is a partition wall that partitions an engine room and the vehicle interior (cabin) of the vehicle 100, and forms a structural member (frame member) of the vehicle 100.

Moreover, a reinforcing member 120 installed inside an instrument panel of the vehicle 100 is provided above the wire harness routing structure 1. The reinforcing member 120 is, for example, a metallic hollow pipe, and is a reinforcement or the like extending along the vehicle width direction. Flanges 121 are joined to both ends of the reinforcing member 120. One of the pair of flanges 121 is fixed to the left side of the body of the vehicle 100, and the other is fixed to the right side of the body of the vehicle 100.

Note that in the following description, among a first direction, a second direction, and a third direction intersecting each other, the first direction is referred to as a “vehicle front-rear direction X”, the second direction is referred to as a “vehicle width direction Y”, and the third direction is referred to as a “vehicle height direction Z”. Here, the vehicle front-rear direction X, the vehicle width direction Y, and the vehicle height direction Z are substantially orthogonal to each other. The vehicle front-rear direction X typically corresponds to the entire length direction of the vehicle 100, the stacking direction of the wire harness routing structure 1, and the like. The vehicle width direction Y typically corresponds to the entire width direction of the vehicle 100, the longitudinal direction (extending direction) of the wire harness routing structure 1, and the like. The vehicle height direction Z typically corresponds to a vehicle height direction of the vehicle 100, the lateral direction of the wire harness routing structure 1, and the like.

Note that each direction used in the following description will be described as a direction in a state where the wire harness routing structure 1 is assembled to the vehicle 100, unless otherwise specified. Additionally, in the following description, for convenience, it is assumed that a stacking direction of the wire harness routing structure 1, that is, an opening direction of a groove 111 (plate thickness direction of lid member 20) to be described later, is along the vehicle front-rear direction X, but the stacking direction of the wire harness routing structure 1 may be along an inclination direction between the vehicle front-rear direction X and the vehicle height direction Z.

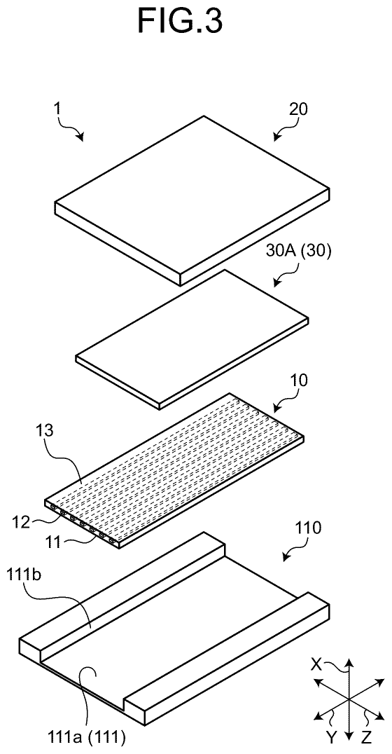

FIG. 2 is a perspective view of the wire harness routing structure 1, and FIG. 3 is an exploded perspective view of the wire harness routing structure 1. As illustrated in FIGS. 2 and 3, the wire harness routing structure 1 includes, for example, the groove 111, a flat routing member 10, the lid member 20, and an elastic member 30. The groove 111 is a recess formed in the dash panel 110 which is an example of the above-described body member of the vehicle 100, and extends along the vehicle width direction Y. The groove 111 is recessed from an inner surface of the dash panel 110 toward the front side in the vehicle front-rear direction X and is opened toward the rear side in the vehicle front-rear direction X. The flat routing member 10 is accommodated and routed in the groove 111 along the vehicle width direction Y.

For example, the groove 111 integrally extends along the vehicle width direction Y so as to extend between a first ECU 5A (see FIG. 1) of a control device 5 provided at one end in the vehicle width direction Y and a second ECU 5B of the control device 5 provided at the other end in the vehicle width direction Y. In the present embodiment, the flat routing member 10 has one end 10a and the other end 10b drawn out to the outside so as to rise from the groove 111. For example, the one end 10a and the other end 10b are folded back toward the upper side in the vehicle height direction Z with respect to the main body of the flat routing member 10 via a fold-back portion. Then, the one end 10a is connected to the first ECU 5A via a connector or the like, and the other end 10b is connected to the second ECU 5B via a connector or the like. Note that the first ECU 5A and the second ECU 5B here are typically zone ECUs that integrally control devices in a peripheral region (zone) of the dash panel 110, but are not limited thereto.

The flat routing member 10 is a routing member forming the wire harness, and is formed by, for example, flexible printed circuits (FPC), flexible flat cable (FFC), or the like. The flat routing member 10 is a thin and flexible flat routing member. The flat routing member 10 is formed in a rectangular shape horizontally long in the vehicle width direction Y as a whole. The flat routing member 10 includes, for example, a base film 11 (see FIG. 3), a wiring pattern 12, and a cover lay 13.

The base film 11 is a base material having excellent flexibility and defining the overall shape of the flat routing member 10. The base film 11 is formed of, for example, a polyimide resin or the like having excellent heat resistance. The wiring pattern 12 is laminated on the surface (mounting surface) of the base film 11, for example, and forms a plurality of conductor circuit portions (pattern layers). The wiring pattern 12 is formed of a conductive material such as copper foil, and is printed as a printed circuit body on the surface of the base film 11. The cover lay 13 is laminated on the entire surface of the base film 11 via an adhesive (not illustrated), and functions as a protective layer for protecting the conductor circuit portion and the like of the wiring pattern 12.

In addition, the plurality of conductor circuit portions formed by the wiring pattern 12 can function as, for example, any circuit such as a signal circuit, a signal GND circuit, or a power ground circuit. The signal circuit is, for example, a circuit that transmits a communication signal between the control device 5 and in-vehicle devices such as various electronic devices in the vehicle 100. The signal GND circuit is a circuit that conducts between in-vehicle devices in association with the signal circuit and adjusts a potential serving as a reference of a circuit operation between the in-vehicle devices. The power ground circuit is a circuit that grounds a power supply system of the in-vehicle device.

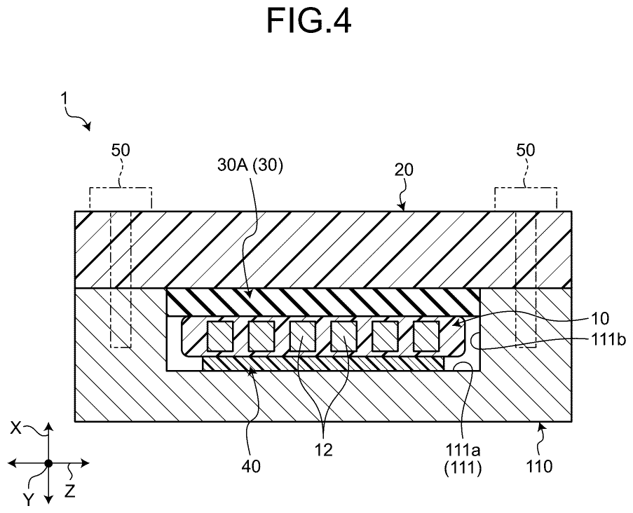

FIG. 4 is a cross-sectional view of the wire harness routing structure 1. As illustrated in FIG. 4, the lid member 20 closes the groove 111 in a state where the flat routing member 10 is accommodated in the groove 111. The lid member 20 is formed of, for example, a synthetic resin material or the like into a rectangular plate shape that is horizontally long in the vehicle width direction Y. The length of the lid member 20 along the vehicle width direction Y is, for example, shorter than the length of the groove 111 along the vehicle width direction Y by openings from which the one end 10a and the other end 10b of the flat routing member 10 are drawn out. For example, the lid member 20 may be formed by one component integrally extending along the vehicle width direction Y, or may be formed by a plurality of divided bodies divided along the vehicle width direction Y.

The lid member 20 is assembled to the dash panel 110 so as to cover the groove 111 from the rear side in the vehicle front-rear direction X. For example, the lid member 20 is fastened (fixed) to the inner surface of the dash panel 110 via a fastening member 50 such as a bolt that penetrates the lid member 20 and the inner surface of the dash panel 110 along the vehicle front-rear direction X, the lid member 20 being overlaid on the inner surface of the dash panel 110. Note that the lid member 20 is not limited to this example, and may be configured to be fixed to the dash panel 110 by, for example, so-called snap-fit by claw fitting.

The elastic member 30 is interposed between the flat routing member 10 and the lid member 20 in an elastically compressed state, and is a member that fills a gap between the flat routing member 10 and the lid member 20. The elastic member 30 is formed of, for example, a synthetic resin material or the like into a rectangular plate shape that is horizontally long in the vehicle width direction Y. The length of the elastic member 30 along the vehicle width direction Y is, for example, substantially the same as the length of the lid member 20 along the vehicle width direction Y. For example, the elastic member 30 is assembled into the groove 111 from the rear side in the vehicle front-rear direction X with respect to the dash panel 110 in a state of being integrated with the lid member 20. Furthermore, for example, the width of the elastic member 30 along the vehicle height direction Z in a free state is configured to be substantially the same as the width between a pair of side surfaces 111b of the groove 111 along the vehicle height direction z.

In addition, the elastic member 30 is formed of, for example, a sound absorbing material 30A. The sound absorbing material 30A is formed by finely dispersing a gas in a synthetic resin and molding it into a foamed or porous shape, and as an example, a urethane sponge or the like can be applied. For example, the sound absorbing material 30A (elastic member 30) curbs rattling of the flat routing member 10 in the groove 111 due to vibration or the like of the vehicle 100 input to the dash panel 110, and can absorb abnormal noise or the like generated by the rattling of the flat routing member 10.

Additionally, in the present embodiment, a bottom surface 111a of the groove 111 is provided with a bonding portion 40 for bonding the flat routing member 10. The bonding portion 40 is formed of, for example, a double-sided tape, an adhesive, or the like, and extends along the vehicle width direction Y. The bonding portion 40 is provided corresponding to a main body of the flat routing member 10, that is, a portion excluding the one end 10a and the other end 10b drawn out from the groove 111 described above, and can fix the main body of the flat routing member 10 to the bottom surface 111a of the groove 111.

As described above, the wire harness routing structure 1 of the present embodiment is configured to include the flat routing member 10. Therefore, the wire harness formed of the flat routing member 10 is reduced in weight as compared with a general wire harness in which various electrical wires are bundled. Here, in a case where the wire harness routing structure 1 is installed in the vehicle 100, the length of the wire harness is assumed to be about 1000 mm, and if all the wire harnesses of such a length are formed of electric wires, the weight of the entire wire harness may increase. In this regard, according to the present embodiment, since the wire harness includes the flat routing member 10, it is possible to cope with an increase in size of the wire harness while curbing an increase in weight of the entire wire harness.

Moreover, in general, a wire harness in which various electrical wires are bundled is manufactured manually by an operator. Meanwhile, since the flat routing member 10 can be manufactured by automation, it is also possible to reduce the number of manufacturing steps of the wire harness by forming the wire harness with the flat routing member 10. Additionally, in general, a large wire harness in which various electrical wires are bundled has difficulty in transportation due to its weight. Meanwhile, according to the present embodiment, the flat routing member 10 also has an advantage that, for example, the number of manufacturing days of the wire harness itself or the vehicle 100 using the wire harness is shortened, or the manufacturing place is hardly limited.

As described above, the wire harness routing structure 1 of the present embodiment includes the groove 111 formed in the dash panel 110 which is an example of a body member of the vehicle 100, the flat routing member 10 which is accommodated in the groove 111 of the dash panel 110 and has flexibility, and the lid member 20 which closes the groove 111 in a state where the flat routing member 10 is accommodated in the groove 111 of the dash panel 110. With this configuration, the wire harness routing structure 1 can assemble the flat routing member 10 forming the wire harness to the vehicle 100 by closing the groove 111 formed in the dash panel 110 with the lid member 20 in a state where the flat routing member 10 is accommodated in the groove 111, for example. As a result, the wire harness routing structure 1 can improve the assemblability to the vehicle 100.

In addition, the wire harness routing structure 1 of the present embodiment includes the elastic member 30 interposed between the flat routing member 10 and the lid member 20 in an elastically compressed state. With this configuration, in the wire harness routing structure 1, since the gap between the flat routing member 10 and the lid member 20 can be filled with the elastic member 30, for example, rattling of the flat routing member 10 in the groove 111 due to vibration or the like of the vehicle 100 input to the dash panel 110 can be curbed, and generation of abnormal noise or the like caused by the rattling of the flat routing member 10 can also be curbed.

In the wire harness routing structure 1 of the present embodiment, the elastic member 30 is formed of the sound absorbing material 30A. With this configuration, in the wire harness routing structure 1, for example, the sound absorbing material 30A can further curb generation of abnormal noise caused by vibration of the vehicle 100 input to the dash panel 110, rattling of the flat routing member 10, and the like.

Additionally, in the wire harness routing structure 1 of the present embodiment, the bottom surface 111a of the groove 111 is provided with the bonding portion 40 for bonding the flat routing member 10. With this configuration, in the wire harness routing structure 1, since the flat routing member 10 can be fixed to the bottom surface 111a of the groove 111 by the bonding portion 40, for example, it is possible to keep the flat routing member 10 from moving relative to the dash panel 110 or rattling due to the vibration of the vehicle 100 input to the dash panel 110.

Moreover, in the wire harness routing structure 1 of the present embodiment, the flat routing member 10 has one end 10a and the other end 10b that are drawn out so as to rise from the groove 111 and connected to the control device 5. With this configuration, in the wire harness routing structure 1, for example, the main body between the one end 10a and the other end 10b of the flat routing member 10 can be accommodated in the groove 111 to be more reliably protected, and the one end 10a and the other end 10b can be drawn out from the groove 111 to be connected to the control device 5.

Note that in the present embodiment, the case where the groove 111 continuously extends along the vehicle width direction Y so as to extend between the first ECU 5A and the second ECU 5B of the control device 5 has been exemplified, but the present invention is not limited to this example, and, for example, the groove may be intermittently provided along the vehicle width direction Y. Additionally, in the present embodiment, the case where the elastic member 30 is provided between the flat routing member 10 and the lid member 20 has been exemplified, but the present invention is not limited to this example, and, for example, the elastic member 30 may be omitted. Furthermore, in the present embodiment, the case where the bonding portion 40 for bonding the flat routing member 10 is provided on the bottom surface 111a of the groove 111 has been exemplified, but the present invention is not limited to this example, and, for example, the bonding portion 40 may be omitted.

Although the embodiment of the present invention has been exemplified above, the above embodiment is merely an example, and is not intended to limit the scope of the invention. The above-described embodiment can be implemented in various other forms, and various omissions, substitutions, combinations, and changes can be made without departing from the gist of the invention. In addition, specifications (structure, type, direction, form, size, length, width, thickness, height, number, arrangement, position, material, and the like) of each configuration, shape, and the like can be appropriately changed and implemented.

In a wire harness routing structure according to the present embodiment, a flat routing member forming the wire harness can be assembled to a vehicle by closing a groove formed in a body member with a lid member in a state where the flat routing member is accommodated in the groove. As a result, the wire harness routing structure can improve the assemblability to the vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness routing structure comprising:
a groove formed in a body member of a vehicle;
a flat routing member having flexibility and accommodated in the groove of the body member; and
a lid member that closes the groove in a state where the flat routing member is accommodated in the groove of the body member.

2. The wire harness routing structure according to claim 1, further comprising:
an elastic member interposed between the flat routing member and the lid member in an elastically compressed state.

3. The wire harness routing structure according to claim 2, wherein
the elastic member is formed of a sound absorbing material.

4. The wire harness routing structure according to claim 1, wherein
a bottom surface of the groove is provided with a bonding portion for bonding the flat routing member.

5. The wire harness routing structure according to claim 2, wherein
a bottom surface of the groove is provided with a bonding portion for bonding the flat routing member.

6. The wire harness routing structure according to claim 1, wherein
the flat routing member has ends which are drawn out so as to rise from the groove and are connected to a control device.

7. The wire harness routing structure according to claim 2, wherein
the flat routing member has ends which are drawn out so as to rise from the groove and are connected to a control device.
